(19) United States
(12) Patent Application Publication
(10) Pub. No.: US 2026/0164336 A1
(43) Pub. Date: Jun. 11, 2026

(54) Converged Network Services Using a Network Management System

(71) Applicant: AT&T Intellectual Property I, L.P., Atlanta, GA (US)

(72) Inventors: Rashmi Palamadai, Naperville, IL (US); Yupeng Jia, South Pasadena, CA (US)

(73) Assignee: AT&T Intellectual Property I, L.P., Atlanta, GA (US)

(21) Appl. No.: 18/975,229

(22) Filed: Dec. 10, 2024

(51) Int. Cl. H04W 48/04; H04L 12/46; H04W 36/32

(52) U.S. Cl. CPC H04W 48/04; H04L 12/4641; H04W 36/322

(57) ABSTRACT

Converged network services using a network management system can include detecting, based on activity data generated by monitoring hardware located at a physical location, a user device at the physical location; identifying, based on an identifier, an account associated with the user device, the account comprising a profile including settings for the user device; identifying, based on the activity data, the profile from the account; applying the settings for the user device to the user device; monitoring location and activity of the user device; and in response to determining, based on the location and activity of the user device, that an action should be taken, taking the action to manage access of the user device to a physical resource at the physical location and to manage access of the user device to an electronic resource.

### BACKGROUND

In some situations, a user or user device may have access to certain electronic resources associated with particular physical locations such as office buildings, manufacturing facilities, and the like. For example, a user may be entitled to access an intranet, virtual private network, or the like while at the facility but remote access may be undesirable for various reasons. When a device enters or leaves the facility, however, there may or may not be any awareness of this movement, and devices that are entitled to access resources at the facility may at any rate come and go without any knowledge of facility personnel.

### SUMMARY

The present disclosure is directed to converged network services using a network management system. A network management system can include a network management service, which can be hosted and/or executed by a server computer. The network management service can receive a request to create an account and can receive account data for creating the account. As explained herein, the account data obtained by network management service can define, for a particular user or device such as the user device, one or more identities associated with the user device, one or more profiles that are to be created for the user device, one or more devices that are to be tied to the account, one or more permissions that are to be defined for the account, one or more restrictions that are to be defined for the account, one or more locations and/or location-based restrictions and/or permissions for the account, one or more time-based restrictions and/or permissions for the account, other information, combinations thereof, or the like. The network management service can analyze the account data and define, for a particular user or account, one or more identities, one or more profiles, one or more devices, one or more permissions, one or more restrictions, one or more locations, and/or other aspects of the accounts such as, for example, network permissions and/or restrictions, time permissions and/or restrictions, combinations thereof, or the like. It should be understood that this example embodiment is illustrative, and therefore should not be construed as being limiting in any way.

The network management service can create and save the account. The account can be stored locally (e.g., at a device that hosts and/or executes the network management service such as a server computer) and/or remotely. Wherever the accounts are stored, the network management service can access the accounts and execute queries against the accounts and/or modify the accounts (e.g., based on updated account data or the like). It should be understood that this example embodiment is illustrative, and therefore should not be construed as being limiting in any way.

The network management service can also be configured to detect a user device at a physical location. The user device can be detected at the physical location by receiving, from the user device, from monitoring hardware at the physical location and/or elsewhere, and/or from other sources, activity data that can indicate that the user device has entered the physical location and/or accessed a particular physical resource at the physical location such as a room, door or the like. The monitoring hardware can include access control hardware, cameras, alarm systems, and the like, which in some embodiments can be located at the physical location and elsewhere, and which can be configured to detect entry of the user device into the physical location. It should be understood that this example embodiment is illustrative, and therefore should not be construed as being limiting in any way.

The network management service can identify an account associated with the user device. The network management service can identify, from the account associated with the user device, a profile defined for the physical location. The network management service can apply the profile identified to the user device. Thus, the network management service can apply one or more settings associated with the profile identified to the user device. The settings can include, for example, settings that define what physical resources (e.g., rooms, doors, or the like) can be accessed by the user device, what devices identified in the account are allowed or blocked, what activities are allowed or blocked, what networks and/or network connections are allowed or blocked, what times and/or locations of activity will be allowed or blocked, and other aspects of the accounts and/or profiles thereof as illustrated and described herein, and apply the settings to the user device to manage access to physical resources, networks, virtual private networks, services, and the like by the user device. It should be understood that this example embodiment is illustrative, and therefore should not be construed as being limiting in any way.

The network management service can generate one or more commands for applying the settings of the profile to the user device. The network management service can monitor the location of the user device and activity of the user device. The network management service can determine, based on activity of the user device at the location at which the activity occurred, if an action should be taken. In some embodiments, the network management service may determine that an action should be taken to limit access and/or activity of the user device at the location, to generate an alert for delivery to a delivery recipient, or the like. If the network management service determines that an action is not to be taken, monitoring can continue. If the network management service determines that an action is to be taken, the network management service can take an action with respect to the activity of the user device. For example, an alert can be generated, the network management service can cause some monitored activity to be blocked, or the like. The network management service can create and deliver a command to the network controller, the monitoring hardware, or the user device to block the activity or take other actions. It should be understood that this example embodiment is illustrative, and therefore should not be construed as being limiting in any way.

The network management service can also detect the user device leaving the physical location. The network management service can determine if a handoff is to be performed. The handoff can refer to continuing to monitor a user device after it has left a physical location to provide continuity in terms of monitoring activity and/or location of the user device. If the network management service determines that a handoff should be performed to continue monitoring the user device off-site from the physical location, the network management service can generate commands for managing services and/or other resource access by the user device such as access to physical resources, electronic resources, networks, virtual private networks, or the like. The network management service can activate off-site tracking of the user device. It should be understood that this example embodiment is illustrative, and therefore should not be construed as being limiting in any way.

Embodiments of the concepts and technologies disclosed herein can be used to prevent fraud and/or to detect fraud, as well as to provide tracking of devices that have been associated with questionable activity after departing a controlled and/or monitored facility such as the physical location illustrated and described herein. In some embodiments, suspected fraud events can be provided to a deep learning and/or artificial intelligence module or process (which can be part of the network management service) to learn from the activity and response thereto. The network management service also can operate a feedback loop for feeding monitored activity and/or actions taken based on activity to a deep learning and/or artificial intelligence module or process (which can be part of the network management service) to learn from the activity and response thereto. It should be understood that this example embodiment is illustrative, and therefore should not be construed as being limiting in any way.

Embodiments of the concepts and technologies disclosed herein also can create alarms and/or escalate devices (e.g., by activating off-site monitoring as illustrated and described herein) when a profile does not match the user device, when biometric sensors or devices detect a mismatch, or the like. In some embodiments, any malicious or suspicious activity can prompt the network management service to initiate controls and/or restrictions for the user device, thereby prohibiting access to electronic resources from outside the network, from outside a country associated with the network, or the like. Thus, electronic resources such as virtual private networks can be protected from suspicious or malicious users. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include detecting, based on activity data generated by monitoring hardware located at a physical location, a user device at the physical location. The activity data can include an identifier associated with the user device, activity information that can identify an activity occurring at the physical location, and location information that can identify a geographic location of the user device. The operations can further include identifying, based on the identifier, an account associated with the user device, the account including a profile including settings for the user device; identifying, based on the activity data, the profile from the account; applying the settings for the user device to the user device; monitoring location and activity of the user device; and in response to determining, based on the location and activity of the user device, that an action should be taken, taking the action to manage access of the user device to a physical resource at the physical location and to manage access of the user device to an electronic resource.

In some embodiments, the monitoring hardware can include an access control device that allows or blocks access to the physical resource, and managing access of the user device to the physical resource can include blocking the access of the user device to the physical resource. In some embodiments, the electronic resource can include a virtual private network associated with the physical location, and managing access of the user device to the virtual private network can include blocking access of the user device to the virtual private network. In some embodiments, taking the action can include generating a command and sending the command to a network controller. The network controller can block the access of the user device to the electronic resource. In some embodiments, taking the action can include generating a command and sending the command to a network controller. The network controller can allow the user device to access a virtual private network associated with the physical location.

In some embodiments, the operations can further include detecting, based on the activity data, the user device leaving the physical location; determining if a handoff is to be performed to enable off-site monitoring of the user device; and in response to determining that the handoff is to be performed, activating the off-site monitoring of the user device by a further instance of monitoring hardware. In some embodiments, the operations can further include detecting, based on the activity data, the user device leaving the physical location; determining if a handoff is to be performed to enable off-site monitoring of the user device; in response to determining that the handoff is to be performed, generating a command to manage services associated with the user device; sending the command to a network controller to manage the services associated with the user device; and activating off-site tracking of the user device by a further instance of monitoring hardware.

According to another aspect of the concepts and technologies disclosed herein, a method is disclosed. The method can include detecting, by a computer including a processor and based on activity data generated by monitoring hardware located at a physical location, a user device at the physical location. The activity data can include an identifier associated with the user device, activity information that can identify an activity occurring at the physical location, and location information that can identify a geographic location of the user device. The method can further include identifying, by the processor and based on the identifier, an account associated with the user device, the account including a profile including settings for the user device; identifying, by the processor and based on the activity data, the profile from the account; applying the settings for the user device to the user device; monitoring, by the processor and based on additional instances of activity data, location and activity of the user device; and in response to determining, based on the location and activity of the user device, that an action should be taken, taking, by the processor, the action to manage access of the user device to a physical resource at the physical location and to manage access of the user device to an electronic resource.

In some embodiments, the monitoring hardware can include an access control device that allows or blocks access to the physical resource, and managing access of the user device to the physical resource can include blocking the access of the user device to the physical resource. In some embodiments, the electronic resource can include a virtual private network associated with the physical location, and managing access of the user device to the virtual private network can include blocking access of the user device to the virtual private network. In some embodiments, taking the action can include generating a command and sending the command to a network controller. The network controller can block the access of the user device to the electronic resource. In some embodiments, taking the action can include generating a command and sending the command to a network controller. The network controller can allow the user device to access a virtual private network associated with the physical location.

In some embodiments, the operations can further include detecting, based on the activity data, the user device leaving the physical location; determining if a handoff is to be performed to enable off-site monitoring of the user device; and in response to determining that the handoff is to be performed, activating the off-site monitoring of the user device by a further instance of monitoring hardware. In some embodiments, the operations can further include detecting, based on the activity data, the user device leaving the physical location; determining if a handoff is to be performed to enable off-site monitoring of the user device; in response to determining that the handoff is to be performed, generating a command to manage services associated with the user device; sending the command to a network controller to manage the services associated with the user device; and activating off-site tracking of the user device by a further instance of monitoring hardware.

According to yet another aspect of the concepts and technologies disclosed herein, a computer storage medium is disclosed. The computer storage medium can store computer-executable instructions that, when executed by a processor, cause the processor to perform operations. The operations can include detecting, based on activity data generated by monitoring hardware located at a physical location, a user device at the physical location. The activity data can include an identifier associated with the user device, activity information that can identify an activity occurring at the physical location, and location information that can identify a geographic location of the user device. The operations can further include identifying, based on the identifier, an account associated with the user device, the account including a profile including settings for the user device; identifying, based on the activity data, the profile from the account; applying the settings for the user device to the user device; monitoring location and activity of the user device; and in response to determining, based on the location and activity of the user device, that an action should be taken, taking the action to manage access of the user device to a physical resource at the physical location and to manage access of the user device to an electronic resource.

In some embodiments, the monitoring hardware can include an access control device that allows or blocks access to the physical resource, and managing access of the user device to the physical resource can include blocking the access of the user device to the physical resource. In some embodiments, the electronic resource can include a virtual private network associated with the physical location, and managing access of the user device to the virtual private network can include blocking access of the user device to the virtual private network. In some embodiments, taking the action can include generating a command and sending the command to a network controller. The network controller can block the access of the user device to the electronic resource. In some embodiments, taking the action can include generating a command and sending the command to a network controller. The network controller can allow the user device to access a virtual private network associated with the physical location.

In some embodiments, the operations can further include detecting, based on the activity data, the user device leaving the physical location; determining if a handoff is to be performed to enable off-site monitoring of the user device; and in response to determining that the handoff is to be performed, activating the off-site monitoring of the user device by a further instance of monitoring hardware. In some embodiments, the operations can further include detecting, based on the activity data, the user device leaving the physical location; determining if a handoff is to be performed to enable off-site monitoring of the user device; in response to determining that the handoff is to be performed, generating a command to manage services associated with the user device; sending the command to a network controller to manage the services associated with the user device; and activating off-site tracking of the user device by a further instance of monitoring hardware.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for creating accounts to provide converged network services using a network management system, according to an illustrative embodiment of the concepts and technologies described herein.

FIG. 3 is a flow diagram showing aspects of a method for managing user services at a physical location using a network management system, according to an illustrative embodiment of the concepts and technologies described herein.

FIG. 4 is a flow diagram showing aspects of a method for managing user services away from a physical location using a network management system, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide converged network services using a network management system, according to some illustrative embodiments of the concepts and technologies described herein.

FIG. 7 is a block diagram illustrating an example mobile device configured to interact with a network management system, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to converged network services using a network management system. A network management system can include a network management service, which can be hosted and/or executed by a server computer. The network management service can receive a request to create an account and can receive account data for creating the account. As explained herein, the account data obtained by the network management service can define, for a particular user or device such as the user device, one or more identities associated with the user device, one or more profiles that are to be created for the user device, one or more devices that are to be tied to the account, one or more permissions that are to be defined for the account, one or more restrictions that are to be defined for the account, one or more locations and/or location-based restrictions and/or permissions for the account, one or more time-based restrictions and/or permissions for the account, other information, combinations thereof, or the like. The network management service can analyze the account data and define, for a particular user or account, one or more identities, one or more profiles, one or more devices, one or more permissions, one or more restrictions, one or more locations, and/or other aspects of the accounts such as, for example, network permissions and/or restrictions, time permissions and/or restrictions, combinations thereof, or the like. It should be understood that this example embodiment is illustrative, and therefore should not be construed as being limiting in any way.

The network management service can create and save the account. The account can be stored locally (e.g., at a device that hosts and/or executes the network management service such as a server computer) and/or remotely. Wherever the accounts are stored, the network management service can access the accounts and execute queries against the accounts and/or modify the accounts (e.g., based on updated account data or the like). It should be understood that this example embodiment is illustrative, and therefore should not be construed as being limiting in any way.

The network management service can also be configured to detect a user device at a physical location. The user device can be detected at the physical location by receiving, from the user device, from monitoring hardware at the physical location and/or elsewhere, and/or from other sources, activity data that can indicate that the user device has entered the physical location and/or accessed a particular physical resource at the physical location such as a room, door or the like. The monitoring hardware can include access control hardware, cameras, alarm systems, and the like, which in some embodiments can be located at the physical location and elsewhere, and which can be configured to detect entry of the user device into the physical location. It should be understood that this example embodiment is illustrative, and therefore should not be construed as being limiting in any way.

The network management service can identify an account associated with the user device. The network management service can identify, from the account associated with the user device, a profile defined for the physical location. The network management service can apply the profile identified to the user device. Thus, the network management service can apply one or more settings associated with the profile identified to the user device. The settings can include, for example, settings that define what physical resources (e.g., rooms, doors, or the like) can be accessed by the user device, what devices identified in the account are allowed or blocked, what activities are allowed or blocked, what networks and/or network connections are allowed or blocked, what times and/or locations of activity will be allowed or blocked, and other aspects of the accounts and/or profiles thereof as illustrated and described herein, and apply the settings to the user device to manage access to physical resources, networks, virtual private networks, services, and the like by the user device. It should be understood that this example embodiment is illustrative, and therefore should not be construed as being limiting in any way.

The network management service can generate one or more commands for applying the settings of the profile to the user device. The network management service can monitor the location of the user device and activity of the user device. The network management service can determine, based on activity of the user device at the location at which the activity occurred, if an action should be taken. In some embodiments, the network management service may determine that an action should be taken to limit access and/or activity of the user device at the location, to generate an alert for delivery to a delivery recipient, or the like. If the network management service determines that an action is not to be taken, monitoring can continue. If the network management service determines that an action is to be taken, the network management service can take an action with respect to the activity of the user device. For example, an alert can be generated, the network management service can cause some monitored activity to be blocked, or the like. The network management service can create and deliver a command to the network controller, the monitoring hardware, or the user device to block the activity or take other actions. It should be understood that this example embodiment is illustrative, and therefore should not be construed as being limiting in any way.

The network management service can also detect the user device leaving the physical location. The network management service can determine if a handoff is to be performed. The handoff can refer to continuing to monitor a user device after it has left a physical location to provide continuity in terms of monitoring activity and/or location of the user device. If the network management service determines that a handoff should be performed to continue monitoring the user device off-site from the physical location, the network management service can generate commands for managing services and/or other resource access by the user device such as access to physical resources, electronic resources, networks, virtual private networks, or the like. The network management service can activate off-site tracking of the user device. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

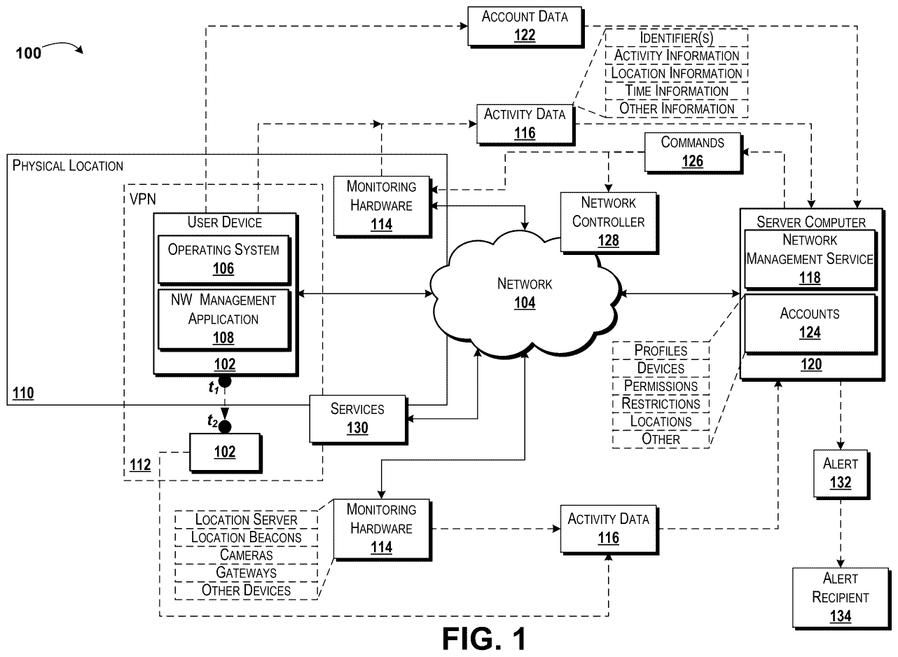

Referring now to FIG. 1, aspects of an operating environment 100 for various embodiments of the concepts and technologies disclosed herein for converged network services using a network management system will be described, according to an illustrative embodiment. The operating environment 100 shown in FIG. 1 includes a user device 102. The user device 102 can operate in communication with and/or as part of a communications network (“network”) 104, though this is not necessarily the case in all embodiments.

According to various embodiments, the functionality of the user device 102 may be provided by one or more desktop computers, mobile telephones, smartphones, laptop computers, tablet computers, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can execute an operating system 106 and one or more application programs such as, for example, a network management application 108. The operating system 106 can include a computer program that can control the operation of the user device 102. The network management application 108 can include an executable program that can be configured to execute on top of the operating system 106 to provide various functions as illustrated and described herein for providing converged network services using a network management system. The functionality of the network management application 108 will be explained in more detail herein after introducing the other entities operating in the operating environment 100.

As shown in FIG. 1, the user device 102 can be located at and/or near a physical location 110 in some embodiments. The physical location 110 can include various types of geographic locations, buildings, areas, or the like. For example, the physical location 110 can include a home, a business, an office, or the like in some embodiments. In some other embodiments, the physical location 110 can include an area bound by geographic boundaries (e.g., a geofence or the like can be defined for the physical location 110 but other physical limits of the physical location 110 may or may not exist). Because a physical location 110 can be defined in additional and/or alternative manners, it should be understood that these example embodiments are illustrative, and therefore should not be construed as being limiting in any way.

In the example illustrated in FIG. 1, the user device 102 is illustrated as being located at the physical location 110 at a first time t₁ and outside of the physical location 110 at a second time t₂. It should be understood that this example embodiment is illustrative, and therefore should not be construed as being limiting in any way. Furthermore, the user device 102 can be configured to connect to a virtual private network 112 (labeled “VPN” in FIG. 1) at various times. It can be appreciated that the user device 102 can connect to the virtual private network 112 from substantially any location in various embodiments and that the virtual private network 112 may not have any corresponding geographic limitations or the like other than restrictions being set for access to the virtual private network 112 in some instances, as illustrated and described herein. It should be understood that this example embodiment is illustrative, and therefore should not be construed as being limiting in any way.

According to various embodiments of the concepts and technologies disclosed herein, the operating environment 100 also can include one or more instances of monitoring hardware 114. The monitoring hardware 114 can include, for example, one or more location servers, one or more location beacons, one or more cameras, one or more gateways, one or more other devices such as, for example, presence sensors, alarm systems, biometric sensors, wireless access points, combinations thereof, or the like. As shown in FIG. 1, instances of monitoring hardware 114 can be located at various locations such as, for example, at and/or in the physical location 110, off-site and/or outside of the physical location 110, or the like. In some embodiments, some or all of the functionality of the instance of monitoring hardware 114 located at the physical location 110 can be provided by hardware at the physical location 110 such as, for example, security hardware, access control hardware, alarm system hardware, cameras, presence sensors, location determination devices, other devices or systems, combinations thereof, or the like.

The monitoring hardware 114 (both at the physical location 110 and/or off-site and/or outside of the physical location 110) can be configured to capture activity data 116 associated with the user device 102 at the physical location 110 and/or away from the physical location 110, as will be explained in more detail herein. The activity data 116 can be reported by the monitoring hardware 114 and/or other devices or entities to a network management service 118, which can be hosted and/or executed by a computing device such as the server computer 120. According to various embodiments, the functionality of the server computer 120 may be provided by one or more server computers, application servers, web servers, other computing systems, and the like. It should be understood that the functionality of the server computer 120 may be provided by a single device, by two or more similar devices, and/or by two or more dissimilar devices. For purposes of describing the concepts and technologies disclosed herein, the server computer 120 is described herein as a server computer that can host an application and/or store data for one or more users. It should be understood that this embodiment is illustrative, and should not be construed as being limiting in any way.

The network management service 118 can be configured to manage access of the user device 102 (and other devices) to one or more electronic resources such as the virtual private network 112, one or more applications, one or more data storage resources, combinations thereof, or the like, as will be explained in more detail herein. The functionality of the network management service 118 will be explained in more detail herein after introducing additional entities operating in the operating environment 100. In any event, it can be appreciated that the server computer 120 executing the network management service 118 can be referred to herein as a “network management system.” It should be understood that this example embodiment is illustrative, and therefore should not be construed as being limiting in any way.

As will be explained in more detail herein, the network management service 118 can be configured to obtain, from the user device 102 and/or other devices, account data 122 for defining one or more accounts 124 for users of, and/or other managed entities associated with, the network management service 118. As will be explained in more detail, the accounts 124 can include, for a particular user or device with whom or which the account 124 is associated, data defining one or more profiles, data identifying one or more devices for the user or device, data defining one or more permissions for the user or device, data defining one or more restrictions for the user or device, data defining one or more locations at which access may be granted or denied for the user or device, and/or other information. The network management service 118 can create the accounts 124 based on the account data 122 and store the accounts 124 at the server computer 120 and/or elsewhere (e.g., data storage devices or resources, databases, data stores, combinations thereof, or the like). It should be understood that this example embodiment is illustrative, and therefore should not be construed as being limiting in any way.

The network management service 118 also can be configured to analyze the activity data 116 and the accounts 124 to determine if any activity associated with the user device 102 (or other devices) should be allowed or blocked (or should prompt other action). In some embodiments, for example, the network management service 118 can be configured to generate one or more commands 126. The commands 126 can include computer-executable instructions that, when executed by a recipient such as a network controller 128 or the monitoring hardware 114, can cause the recipient to make changes to a network 104, a virtual private network 112, access control rights, local network connectivity, and the like (e.g., to allow or block access of the user device 102 to one or more services 130, to the virtual private network 112, to a physical location 110, or the like). It should be understood that this example embodiment is illustrative, and therefore should not be construed as being limiting in any way.

Additionally, or alternatively, the network management service 118 also can be configured to analyze the activity data 116 and the accounts 124 to determine if any activity associated with the user device 102 should prompt creation and/or delivery of an alert 132 to one or more alert recipients 134. The alerts 132 can inform other devices or entities to track the user device 102, to block and/or grant access to one or more services 130 to the user device 102 and/or other entities, to block and/or grant access to the virtual private network 112 to the user device 102, and/or to take other actions as illustrated and described herein. It should be understood that this example embodiment is illustrative, and therefore should not be construed as being limiting in any way.

Now that the entities shown in the operating environment 100 have been introduced, the functionality of the network management application 108 will be explained in more detail. The network management application 108 can be configured to provide communications between the user device 102 and the network management service 118 in various embodiments; to collect and/or provide information for the network management service 118 (e.g., the account data 122); to collect and/or share operational information associated with the user device 102 (e.g., location information, biometric information, or the like); to enable access to access-controlled entities such as the physical location 110, the virtual private network 112, the services 130; combinations thereof; or the like. Thus, the network management application 108 can correspond, in some embodiments, to a mobile application or the like for collecting information that will be used by the network management service 118 and/or for communicating with the network management service 118 as illustrated and described herein. It should be understood that this example embodiment is illustrative, and therefore should not be construed as being limiting in any way.

According to various embodiments of the concepts and technologies disclosed herein, the network management application 108 also can be configured to monitor usage of the user device 102 such as, for example, monitoring location of the user device 102, monitoring application and/or networking usage of the user device 102 (e.g., detecting if the user device 102 is connected to a network 104 and/or the virtual private network 112, or the like), monitoring and/or authenticating a user of the user device 102 (e.g., using a biometric sensor, or the like), combinations thereof, or the like. The network management application 108 therefore can be configured to determine, at any time, where the user device 102 is located, what network(s) the user device 102 is connected to, what resources (on the user device 102 and/or off the user device 102) are being consumed and/or communicated with by the user device 102 at any particular time, combinations thereof, or the like. This information can be collected by the user device 102 and provided, to the network management service 118 by the user device 102 as shown in FIG. 1. It should be understood that this example embodiment is illustrative, and therefore should not be construed as being limiting in any way.

The network management service 118 can be configured to create the accounts 124 and to manage services 130 and/or other resource access and/or usage by a device associated with one or more accounts 124 based on the accounts 124, activity data 116, and/or other information (e.g., network data from one or more network monitors, malware reports, etc.). Although the network management service 118 is illustrated and described herein as being an application or service hosted by the server computer 120, some embodiments of the concepts and technologies disclosed herein can include adding functionality similar to the network management service 118 in other devices and/or at other locations, for example as a distributed application that can operate on the monitoring hardware 114, in the network 104, and/or elsewhere. It should be understood that this example embodiment is illustrative, and therefore should not be construed as being limiting in any way.

According to various embodiments, the network management service 118 can be configured to detect a request to create an account 124. The request can come from a device (e.g., the user device 102, a network operator, or the like). The network management service 118 can obtain account data 122 from the user device 102 or other device. The account data 122 can define, for a particular user or device such as the user device 102, one or more profiles that are to be created for the user device 102, one or more devices that are to be tied to the account 124, one or more permissions that are to be defined for the account 124, one or more restrictions that are to be defined for the account 124, one or more locations and/or location-based restrictions or permissions for the account 124, other information, combinations thereof, or the like. Thus, the network management service 118 can be configured to analyze the account data 122 and to define, for a particular user or account, one or more identities, one or more profiles, one or more devices, one or more permissions, one or more restrictions, one or more locations, or other information (e.g., one or more networks that can be restricted or allowed, time limits, combinations thereof, or the like).

The identities can identify a user or device (e.g., the user device 102) associated with the account 124 being created. According to various embodiments of the concepts and technologies disclosed herein, the user and/or device can be identified by one or more logins associated with the user, one or more email addresses associated with the user, one or more names associated with the user or device, one or more phone numbers associated with the user or device, one or more serial numbers associated with the device, one or more media access control (“MAC”) addresses associated with the device, one or more Internet Protocol (“IP”) addresses associated with the device, one or more international mobile equipment identities (“IMEIs”) associated with the device, one or more international mobile subscriber identities (“IMSIs”) associated with the user or device, one or more globally unique identifiers (“GUIDs”), and/or one or more other identifiers. The identifier(s) can be included in and/or associated with the account 124 to enable identification of accounts 124 based on identifying users and/or devices. Because the user and/or device can be identified in additional and/or alternative manners, it should be understood that these example embodiments are illustrative, and therefore should not be construed as being limiting in any way.

The profiles can include one or more groups of settings for a particular user or device such as the user device 102. In some embodiments, for example, a personal profile and a business profile can be defined for a particular user or device such as the user device 102. Thus, for example, a first group of settings (e.g., allowed devices, permissions, restrictions, locations, time limits, or the like) can be applied to the user or device when the device is used for business purposes and a second group of settings can be applied to the user or device when the device is used for personal purposes. In some other examples, an authorized user profile and a guest profile can be created for a particular user or device such as the user device 102. Thus, for example, a first group of settings (e.g., allowed devices, permissions, restrictions, locations, time limits, or the like) can be applied to the user or device when the device is located at a physical location 110 as an employee or other authorized user and a second group of settings can be applied to the user or device when the device is located at the physical location 110 as a guest. Because additional and/or alternative profiles can be created and/or applied, it should be understood that the above example embodiments are illustrative, and therefore should not be construed as being limiting in any way.

The devices can include one or more devices associated with the account 124. Thus, for example, an account 124 can define one or more devices that may be used by a particular user. The devices can include, for example, the user device 102, wearables associated with the user device 102, biometric devices associated with the user device 102, or other devices that may be used by a user of the user device 102 and/or other entity or device associated with the account 124. The other devices tied to an account can also be identified in any number of manners including, but not limited to, one or more serial numbers, MAC addresses, IP addresses, IMEIs, and/or other identifiers. Because other devices can be tied to an account 124 and because other identifiers can be used to identify the devices, it should be understood that these example embodiments are illustrative, and therefore should not be construed as being limiting in any way.

The permissions can define permissions for the user and/or device such as the user device 102. In particular, the permissions can identify one or more networks 104 that the user or device can access; times at which the user or device can use particular networks, services 130, virtual private networks 112, or the like; physical locations 110 at which the user or device will be allowed to access networks, services 130, virtual private networks 112, or the like; combinations thereof; or the like. Thus, the permissions can be used to allow access to various resources if not subject to other limitations or blocks, or the like. It should be understood that this example embodiment is illustrative, and therefore should not be construed as being limiting in any way.

The restrictions can define restricted resources or the like for the user and/or device such as the user device 102. In particular, the restrictions can identify one or more networks 104 that the user or device is not allowed to access; times at which the user or device is not allowed to access particular networks, services 130, virtual private networks 112, or the like; physical locations 110 at which the user or device is not allowed to access particular networks, services 130, virtual private networks 112, or the like; combinations thereof; or the like. Thus, the restrictions can be used to block access to various resources even if not subject to other limitations or blocks, or the like. It should be understood that this example embodiment is illustrative, and therefore should not be construed as being limiting in any way.

The locations can define one or more geographic locations that affect usage and/or access associated with the user and/or device such as the user device 102. In particular, the locations can identify geographic locations at which the user or device can access one or more networks 104, virtual private networks 112, services 130, or the like; geographic locations at which the user or device will not be allowed to access networks 104, virtual private networks 112, services 130, or the like; or other location-based limitations on the user or device. It should be understood that this example embodiment is illustrative, and therefore should not be construed as being limiting in any way.

Other information can include, for example, one or more networks to which connections by the user device 102 are to be granted, allowed, or allowed under certain circumstances; time limits such as times of day that activity or connections will be allowed or blocked, time duration limits for connections or use of a service 130, days or schedules of access to physical locations 110, virtual private networks 112, and/or services 130; or the like. Because other information can include other information as illustrated and described herein, it should be understood that these example embodiments are illustrative, and therefore should not be construed as being limiting in any way.

Based on the above and other information included in the account data 122, the network management service 118 can create the accounts 124 and save the accounts 124 locally and/or remotely. Namely, as explained herein, the accounts 124 can be stored at a local device or resource, a remote device or resource, or the like. Thus, the network management service 118 can be configured to access the accounts 124 at almost any time, to search the accounts 124, to retrieve one or more accounts 124, and the like. It should be understood that this example embodiment is illustrative, and therefore should not be construed as being limiting in any way.

According to embodiments, the network management service 118 can be configured to detect a device such as the user device 102 at a physical location 110 (for which network management is provided by the network management service 118). According to various embodiments of the concepts and technologies disclosed herein, the network management service 118 can detect that the user device 102 is at the physical location 110 by receiving, from monitoring hardware 114 at the physical location 110 and/or elsewhere, information such as the activity data 116, which can indicate that the user device 102 has entered the physical location 110. In some embodiments, as explained herein, the monitoring hardware 114 can include access control hardware, cameras, alarm systems, and the like at the physical location 110, and these and/or other systems and/or devices can detect entry of the user device 102 to the physical location 110 in various manners. The information used by the network management service 118 to detect the user device 102 at the physical location 110 (e.g., the activity data 116) can also include information identifying the user device 102 (e.g., by user name, IMSI, IMEI, login, combinations thereof, or the like). Thus, the network management service 118 can detect entry of the user device 102 to the physical location 110 and know the identity of the user associated with the user device 102 in various embodiments. It should be understood that this example embodiment is illustrative, and therefore should not be construed as being limiting in any way.

Upon detecting the user device 102 entering the physical location 110, the network management service 118 can access the accounts 124 and retrieve an account 124 associated with the user device 102. As explained herein, the accounts 124 can include one or more identifiers, so the network management service 118 can search the accounts 124 based on the identifying information obtained as part of the activity data 116 in various embodiments. It should be understood that this example embodiment is illustrative, and therefore should not be construed as being limiting in any way.

The network management service 118 can obtain the relevant account 124 (e.g., the account 124 associated with the user of the user device 102). The network management service 118 also can access the account 124 to identify one or more profiles (of the account 124) that apply at the location where the activity occurred. As explained herein, the activity data 116 received by the network management service 118 can include various types of information identifying the activity that has occurred and/or is occurring at the physical location 110 including one or more identifiers that identify the user device 102, activity information that describes what activity has occurred and/or is occurring associated with the user device 102, location information that identifies the location at which the activity occurred and/or is occurring, time information that identifies a time at which the activity occurred and/or is occurring, and/or other information describing the activity. It should be understood that this example embodiment is illustrative, and therefore should not be construed as being limiting in any way. Based on this and/or other information, the network management service 118 can determine one or more profiles (of the account 124) that apply at the physical location 110 for the user device 102. For example, if the physical location 110 corresponds to a work location for a user of the user device 102, the network management service 118 can identify a “work profile” from the account 124 (if such exists) and apply that profile to the activity of the user device 102. It should be understood that this example embodiment is illustrative, and therefore should not be construed as being limiting in any way.

The network management service 118 can apply the identified profile to the user device 102. Thus, for example, the network management service 118 can identify one or more settings associated with the profile of the account 124 (e.g., settings defining what devices are allowed or blocked, what activities are allowed or blocked, what networks and/or network connections are allowed or blocked, what times and/or locations of activity will be allowed or blocked, and other aspects of the profiles as illustrated and described herein) and apply the settings to the user device 102 to manage access to networks, virtual private networks 112, services 130, and the like for the user device 102.

The network management service 118 can monitor activity and location of the user device 102. In particular, as is illustrated and described herein, the network management service 118 can obtain, for example by requesting, receiving, and/or otherwise accessing instances and/or streams of activity data 116 and determining, based on the activity data 116, activity of the user device 102, locations of the user device 102, and/or other aspects of the activity and/or location as illustrated and described herein. Based on the analysis of the activity data 116, the network management service 118 can determine if any action is to be taken. For example, if the network management service 118 determines that activity of the user device 102 deviates from normal and/or allowed activity of the user device 102 (e.g., in terms of exceeding profile settings, location limits, time limits, access limits, and/or other aspects of the accounts 124 and/or profiles thereof), the network management service 118 can determine that an alert 132 should be generated and can create and deliver the alert 132 to an alert recipient 134, that activity should be blocked and deliver a command 126 to the network controller 128 or the monitoring hardware 114 to block the activity, that additional review of the activity should be performed and take steps to obtain that review, and/or take other actions as illustrated and described herein. Because various actions can be taken in accordance with various embodiments of the concepts and technologies disclosed herein, it should be understood that these example actions are illustrative, and therefore should not be construed as being limiting in any way.

If the network management service 118 determines that no action is to be taken (e.g., that activity of the user device 102 meets expectations and/or falls within defined limits of the account 124 for the user device 102), the network management service 118 can continue monitoring until the user device 102 leaves the physical location 110 and/or otherwise no longer requires monitoring. In any event (e.g., whether action is or is not determined by the network management service 118 to be needed), the network management service 118 can continue monitoring the user device 102 to identify a handoff situation and manage the handoff if needed. It should be understood that this example embodiment is illustrative, and therefore should not be construed as being limiting in any way.

In particular, at some time the network management service 118 can detect that the user device 102 is leaving or has left the physical location 110. The network management service 118 can detect the user device 102 leaving the physical location 110 by monitoring location and/or otherwise detecting that the user device 102 is not located at the physical location 110 based on activity data 116 and/or other information. Based on detecting the exit of the user device 102 from the physical location 110, the network management service 118 can determine if a handoff (for continued monitoring) should be performed to continue monitoring the user device 102 off-site from the physical location 110. For example, if the network management service 118 detected unexpected and/or unallowed activity at the physical location 110, the network management service 118 can determine that continued monitoring is desired and perform the handoff as illustrated and described herein. Because the network management service 118 can perform the handoff illustrated and described herein at any time and with or without detecting particular activity associated with the user device 102 (e.g., the network management service 118 can determine that the handoff is to be performed based on the user device 102 leaving the physical location 110, based on a default rule, based on a setting, based on configurations, or the like), it should be understood that this example embodiment is illustrative, and therefore should not be construed as being limiting in any way.

At any rate, when the network management service 118 determines that a handoff is to be performed, the network management service 118 can generate one or more commands 126 to manage services 130, access to the physical location 110, and/or various other activities and/or connections of the user device 102 at the physical location 110 and/or elsewhere. As explained herein, the commands 126 can cause a recipient thereof to take actions to modify an ability of the user device 102 to create and/or use connections and/or perform other activity (e.g., block physical access at the physical location, block network connections of the user device 102 at various locations, etc.) of the user device 102. It should be understood that this example embodiment is illustrative, and therefore should not be construed as being limiting in any way. The commands 126 can also cause the monitoring hardware 114 that operates off-site (form the physical location 110) to monitor location and/or activity of the user device 102 outside of the physical location 110. Thus, continued monitoring of the user device 102 and/or activity thereof can continue once the user device 102 leaves the physical location 110 when a handoff is requested. Because monitoring of the user device 102 outside of the physical location 110 can be conducted for additional and/or alternative reasons, it should be understood that these example embodiments are illustrative, and therefore should not be construed as being limiting in any way.

In practice, a network management service 118 can be hosted and/or executed by a server computer 120. The network management service 118 can receive a request to create an account 124 and can receive account data 122 for creating the account 124. As explained herein, the account data 122 obtained by network management service 118 can define, for a particular user or device such as the user device 102, one or more identities associated with the user device 102, one or more profiles that are to be created for the user device 102, one or more devices that are to be tied to the account 124, one or more permissions that are to be defined for the account 124, one or more restrictions that are to be defined for the account 124, one or more locations and/or location-based restrictions and/or permissions for the account 124, one or more time-based restrictions and/or permissions for the account 124, other information, combinations thereof, or the like. The network management service 118 can analyze the account data 122 and define, for a particular user or account, one or more identities, one or more profiles, one or more devices, one or more permissions, one or more restrictions, one or more locations, and/or other aspects of the accounts 124 such as, for example, network permissions and/or restrictions, time permissions and/or restrictions, combinations thereof, or the like. It should be understood that this example embodiment is illustrative, and therefore should not be construed as being limiting in any way.

The network management service 118 can create and save the account 124. The account 124 can be stored locally (e.g., at a device that hosts and/or executes the network management service 118 such as a server computer 120) and/or remotely. Wherever the accounts 124 are stored, the network management service 118 can access the accounts 124 and execute queries against the accounts 124 and/or modify the accounts 124 (e.g., based on updated account data 122 or the like). It should be understood that this example embodiment is illustrative, and therefore should not be construed as being limiting in any way.

The network management service 118 can also be configured to detect a user device 102 at a physical location 110. The user device 102 can be detected at the physical location 110 by receiving, from the user device 102, from monitoring hardware 114 at the physical location 110 and/or elsewhere, and/or from other sources, activity data 116 that can indicate that the user device 102 has entered the physical location 110 and/or accessed a particular physical resource at the physical location 110 such as a room, door or the like. The monitoring hardware 114 can include access control hardware, cameras, alarm systems, and the like, which in some embodiments can be located at the physical location 110 and elsewhere, and which can be configured to detect entry of the user device 102 into the physical location 110. It should be understood that this example embodiment is illustrative, and therefore should not be construed as being limiting in any way.

The network management service 118 can identify an account 124 associated with the user device 102. The network management service 118 can identify, from the account 124 associated with the user device 102, a profile defined for the physical location 110. The network management service 118 can apply the profile identified to the user device 102. Thus, the network management service 118 can apply one or more settings associated with the profile identified to the user device 102. The settings can include, for example, settings that define what physical resources (e.g., rooms, doors, or the like) can be accessed by the user device 102, what devices identified in the account 124 are allowed or blocked, what activities are allowed or blocked, what networks and/or network connections are allowed or blocked, what times and/or locations of activity will be allowed or blocked, and other aspects of the accounts 124 and/or profiles thereof as illustrated and described herein, and apply the settings to the user device 102 to manage access to physical resources, networks, virtual private networks 112, services 130, and the like by the user device 102. It should be understood that this example embodiment is illustrative, and therefore should not be construed as being limiting in any way.

The network management service 118 can generate one or more commands 126 for applying the settings of the profile to the user device 102. The network management service 118 can monitor the location of the user device 102 and activity of the user device 102. The network management service 118 can determine, based on activity of the user device 102 at the location at which the activity occurred, if an action should be taken. In some embodiments, the network management service 118 may determine that an action should be taken to limit access and/or activity of the user device 102 at the location, to generate an alert 132 for delivery to a delivery recipient 134, or the like. If the network management service 118 determines that an action is not to be taken, monitoring can continue. If the network management service 118 determines that an action is to be taken, the network management service 118 can take an action with respect to the activity of the user device 102. For example, an alert 132 can be generated, the network management service 118 can cause some monitored activity to be blocked, or the like. The network management service 118 can create and deliver a command 126 to the network controller 128, the monitoring hardware 114, or the user device 102 to block the activity or take other actions. It should be understood that this example embodiment is illustrative, and therefore should not be construed as being limiting in any way.

The network management service 118 can also detect the user device 102 leaving the physical location 110. The network management service 118 can determine if a handoff is to be performed. The handoff can refer to continuing to monitor a user device 102 after it has left a physical location 110 to provide continuity in terms of monitoring activity and/or location of the user device 102. If the network management service 118 determines that a handoff should be performed to continue monitoring the user device 102 off-site from the physical location 110, the network management service 118 can generate commands 126 for managing services 130 and/or other resource access by the user device 102 such as access to physical resources, electronic resources, networks, virtual private networks 112, or the like. The network management service 118 can activate off-site tracking of the user device 102. It should be understood that this example embodiment is illustrative, and therefore should not be construed as being limiting in any way.

FIG. 1 illustrates one user device 102, one network 104, one physical location 110, one virtual private network 112, two instances of monitoring hardware 114, one server computer 120, and one network controller 128. It should be understood, however, that various implementations of the operating environment 100 can include zero, one, or more than one user device 102; zero, one, or more than one network 104; one or more than one physical location 110; one or more than one virtual private network 112; one, two, or more than two instances of monitoring hardware 114; zero, one, or more than one server computer 120; and zero, one, or more than one network controller 128. As such, the illustrated embodiment should be understood as being illustrative, and should not be construed as being limiting in any way.

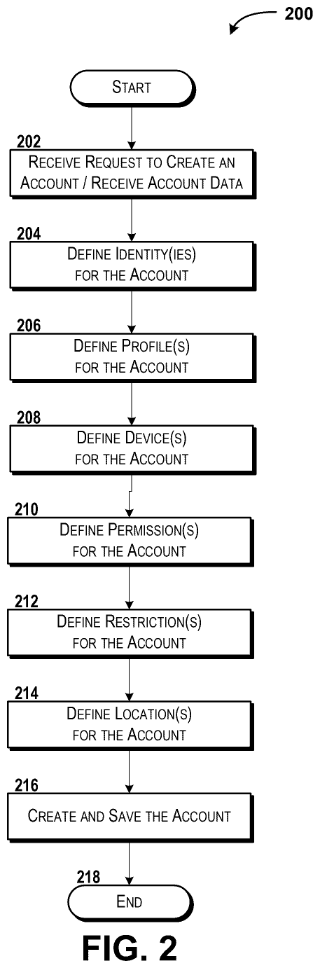

Turning now to FIG. 2, aspects of a method 200 for creating accounts to provide converged network services using a network management system will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the server computer 120, to perform one or more operations and/or causing the processor to direct other components of the computing system or device to perform one or more of the operations.

For purposes of illustrating and describing the concepts of the present disclosure, the method 200 is described herein as being performed by the server computer 120 via execution of one or more software modules such as, for example, the network management service 118. It should be understood that additional and/or alternative devices and/or network nodes can provide the functionality described herein via execution of one or more modules, applications, and/or other software including, but not limited to, the network management service 118. Thus, the illustrated embodiments are illustrative, and should not be viewed as being limiting in any way.

The method 200 begins at operation 202. At operation 202, the server computer 120 can receive a request to create an account 124 (e.g., an account 124 to be used with the network management service 118). In various embodiments, including the illustrated embodiment of FIG. 2, the server computer 120 also can receive account data 122. The account data 122 can be received with the request to create the account 124 or separately in various embodiments. According to various embodiments, the request of operation 202 can be received as a request (e.g., an explicit request, a service call, or the like), or as a command that instructs the server computer 120 to create the account 124 in various embodiments. As such, it should be understood that the illustrated embodiment of FIG. 2 is illustrative and should not be construed as being limiting in any way.

At any rate, according to various embodiments of the concepts and technologies disclosed herein, the request received or otherwise obtained or detected in operation 202 can be received from a device such as the user device 102 or other device associated with a user, network operator, or other authorized entity. In some embodiments, the request (and the account data 122) can be received via an interface, portal, website, or the like. Because the request (or command) and account data 122 can be received in additional and/or alternative ways, it should be understood that these example embodiments are illustrative, and therefore should not be construed as being limiting in any way.

As explained herein, the account data 122 obtained by the server computer 120 can define, for a particular user or device such as the user device 102, one or more identity associated with the user device 102, one or more profiles that are to be created for the user device 102, one or more devices that are to be tied to the account 124, one or more permissions that are to be defined for the account 124, one or more restrictions that are to be defined for the account 124, one or more locations and/or location-based restrictions or permissions for the account 124, other information, combinations thereof, or the like. Thus, the server computer 120 can be configured to analyze the account data 122 and to define, for a particular user or account, one or more identities, one or more profiles, one or more devices, one or more permissions, one or more restrictions, one or more locations, other information (e.g., one or more networks that can be restricted or allowed, time limits, combinations thereof, or the like). It should be understood that this example embodiment is illustrative, and therefore should not be construed as being limiting in any way.

From operation 202, the method 200 can proceed to operation 204. At operation 204, the server computer 120 can define one or more identities for the account 124. The identities can identify a user or device (e.g., the user device 102) associated with the account 124 being created. As explained herein, the user and/or device such as the user device 102 can be identified by logins, email addresses, names, phone numbers, serial numbers, MAC addresses, IP addresses, IMEIs, webIDs, IMSIs, GUIDs, other identifiers, combinations thereof, or the like. These and/or other identities and/or identifiers can be included in and/or associated with the account 124 to enable identification of an account 124 associated with a particular user or device at some future time. Based on the account data 122, the server computer 120 can identify the one or more identifiers or identities and define the identities in operation 204. It should be understood that this example embodiment is illustrative, and therefore should not be construed as being limiting in any way.

From operation 204, the method 200 can proceed to operation 206. At operation 206, the server computer 120 can define one or more profiles for the account 124. As explained herein, embodiments of the concepts and technologies disclosed herein can support multiple profiles for a user or device (e.g., the user device 102) to enable two or more groups of settings to apply to a particular user or device at various times and/or under particular circumstances. In some embodiments, for example, a user device 102 may have two profiles including a personal profile and a business profile. A first group of settings (e.g., allowed devices, permissions, restrictions, locations, time limits, or the like) can be applied to the user device 102 when being used for personal purposes (e.g., by applying the personal profile), and a second group of settings can be applied to the user device 102 when used for business purposes (e.g., by applying the business profile). Other example profiles include a home network profile, an off-network profile, an international profile, an authorized user profile, a guest profile, a reduced capability profile, a provisional profile or probationary profile (e.g., settings to be applied temporarily to a device when used by a user or entity whose entitlement to some services is being evaluated or introduced slowly, for example), or the like. Based on the account data 122, the server computer 120 can identify these profiles and define the profiles in operation 206. Because additional and/or alternative profiles can be created and/or applied, it should be understood that the above example embodiments are illustrative, and therefore should not be construed as being limiting in any way.

From operation 206, the method 200 can proceed to operation 208. At operation 208, the server computer 120 can define one or more devices for the account 124. The devices defined in operation 208 can include, for example, one or more devices associated with the account 124 that are to be included in the account 124. Thus, for example, an account 124 can define one or more devices that may be used by particular user such as the user device 102, a wearable (e.g., smart glasses, smartwatches, and the like), additional smartphones, desktop computers, laptop computers, biometric devices, combinations thereof, or the like. The devices can also be identified in any number of manners including, but not limited to, one or more serial numbers, MAC addresses, IP addresses, IMEIs, and/or other identifiers. At any rate, based on the account data 122, the server computer 120 can identify these devices and define the devices in operation 208 for the account 124. Because other devices can be tied to an account 124 and because other identifiers can be used to identify the devices, it should be understood that these example embodiments are illustrative, and therefore should not be construed as being limiting in any way.

From operation 208, the method 200 can proceed to operation 210. At operation 210, the server computer 120 can define one or more permissions for the account 124. The permissions defined in operation 210 can define, for the user device 102 and the account 124, permissions for the user device 102. The permissions can identify one or more networks 104 that the user device 102 can access; times at which the user device 102 can use particular networks, services 130, virtual private networks 112, or the like; physical locations 110 at which the user device 102 will be allowed to access networks, services 130, virtual private networks 112, or the like; access control limitations on the user device 102 at the physical location 110 (e.g., time-based restrictions, activity restrictions, profile restrictions, etc.); combinations thereof; or the like. Thus, the permissions can be used to allow access to various physical and/or electronic resources if not subject to other limitations or blocks, or the like. Based on the account data 122, the server computer 120 can identify these and other permissions and define the permissions for the account 124 in operation 210. It should be understood that this example embodiment is illustrative, and therefore should not be construed as being limiting in any way.

From operation 210, the method 200 can proceed to operation 212. At operation 212, the server computer 120 can define one or more restrictions for the account 124. The restrictions defined in operation 212 can define restricted resources or the like for the user device 102 and/or for the account 124. In particular, the restrictions can identify one or more networks 104 that the user device 102 is not allowed to access; one or more physical resources (e.g., rooms, doors, or the like) at the physical location 110 that the user device 102 is not allowed to access at some time, with some profile, or the like; times at which the user device 102 is not allowed to access particular networks, services 130, virtual private networks 112, or the like; physical locations 110 at which the user device 102 is not allowed to access particular physical resources, networks, services 130, virtual private networks 112, or the like; combinations thereof; or the like. Thus, the restrictions can be used to block access, by the user device 102, to various resources even if not subject to other limitations or blocks, or the like. Based on the account data 122, the server computer 120 can identify these and other restrictions and define the restrictions for the account 124 in operation 212. It should be understood that this example embodiment is illustrative, and therefore should not be construed as being limiting in any way.

From operation 212, the method 200 can proceed to operation 214. At operation 214, the server computer 120 can define one or more locations for the account 124. The locations defined in operation 214 can define one or more geographic locations that can affect usage and/or access associated with the user device 102. In particular, the locations can identify geographic locations at which the user device 102 can be allowed to access one or more physical resources (e.g., doors, rooms, or the like), networks 104, virtual private networks 112, services 130, or the like; geographic locations at which the user device 102 will not be allowed to access physical resources (e.g., doors, rooms, or the like), networks 104, virtual private networks 112, services 130, or the like; or other location-based limitations on the user or device. Based on the account data 122, the server computer 120 can identify these and other locations and define the locations for the account 124 in operation 212. It should be understood that this example embodiment is illustrative, and therefore should not be construed as being limiting in any way.

Because the account data 122 can include other types of information as illustrated and described herein, it should be understood that other operations can be performed to define other aspects of the accounts 124 in FIG. 2. For example, the accounts 124 can include information that identifies other users or devices that can inherit the settings from the account 124, networks to which connections by the user device 102 are to be granted, allowed, or allowed under certain circumstances; time limits such as times of day that activity (electronic or physical) or connections will be allowed or blocked, time duration limits for connections, physical access, use of a service 130; days or schedules of access to physical locations 110, virtual private networks 112, and/or services 130; or the like. As such, it should be understood that the illustrated embodiment of the method 200 in FIG. 2 is illustrative and should not be construed as being limiting in any way.

From operation 214, the method 200 can proceed to operation 216. At operation 214, the server computer 120 can create and save the account 124. According to various embodiments, operation 216 can correspond to the server computer 120 collecting the definitions of the various components of the account 124 as defined in operations 204-214 and creating the account 124 based on these definitions. Operation 216 also can include the server computer 120 storing the account 124 locally and/or remotely. Namely, as explained herein, the server computer 120 can store the accounts 124 created in operation 216 at a local device or resource, a remote device or resource, or the like. Wherever the accounts 124 are stored, the server computer 120 can access the accounts 124 at substantially any time, execute queries against the accounts 124 (e.g., to locate or identify an account 124 based on an identifier, user, or the like), and/or modify the accounts 124 (e.g., based on updated account data 122 or the like). It should be understood that this example embodiment is illustrative, and therefore should not be construed as being limiting in any way.

From operation 216, the method 200 can proceed to operation 218. The method 200 can end at operation 218.

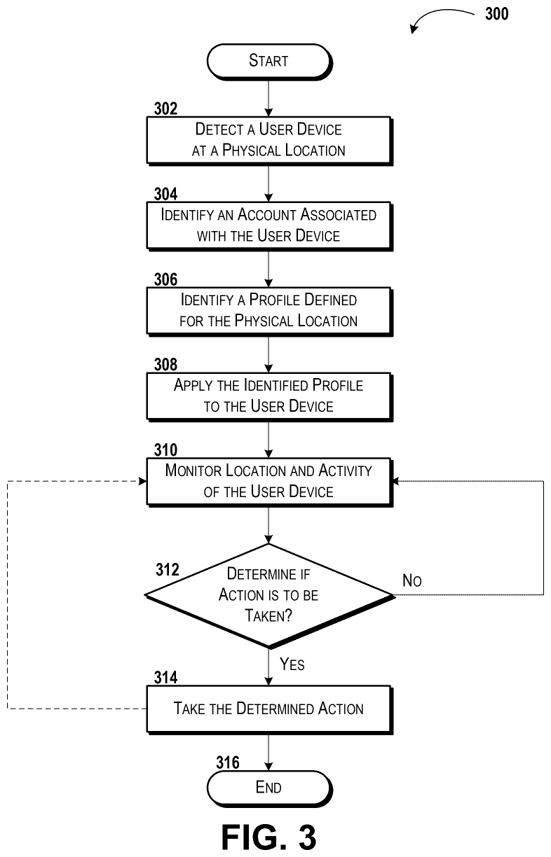

Turning now to FIG. 3, aspects of a method 300 for manage services 130 at a physical location 110 using a network management system will be described in detail, according to an illustrative embodiment. For purposes of illustrating and describing the concepts of the present disclosure, the method 300 is described herein as being performed by the server computer 120 via execution of one or more software modules such as, for example, the network management service 118. It should be understood that additional and/or alternative devices and/or network nodes can provide the functionality described herein via execution of one or more modules, applications, and/or other software including, but not limited to, the network management service 118. Thus, the illustrated embodiments are illustrative, and should not be viewed as being limiting in any way.

The method 300 begins at operation 302. At operation 302, the server computer 120 can detect a user device 102 at a physical location 110. According to various embodiments of the concepts and technologies disclosed herein, the server computer 120 can detect that the user device 102 is at the physical location 110 by receiving, from monitoring hardware 114 at the physical location 110 and/or elsewhere, from the user device 102, and/or from other sources, information such as the activity data 116. The activity data 116 can indicate that the user device 102 has entered the physical location 110 and/or accessed a particular physical resource at the physical location 110 such as a room, door or the like.

In some embodiments, as explained herein, the monitoring hardware 114 can include access control hardware, cameras, alarm systems, and the like, which in some embodiments can be located at the physical location 110 and elsewhere. The monitoring hardware 114 can be configured to detect entry of the user device 102 into the physical location 110. The activity data 116, which can be used by the server computer 120 to detect that the user device 102 has entered into the physical location 110, can also include information that can identify the user device 102 (e.g., by user name, IMSI, IMEI, login, combinations thereof, or the like). Thus, the server computer 120 can detect entry of the user device 102 to the physical location 110 and can also know the identity of the user device 102 in various embodiments. It should be understood that this example embodiment is illustrative, and therefore should not be construed as being limiting in any way.

From operation 302, the method 300 can proceed to operation 304. At operation 304, the server computer 120 can identify an account 124 associated with the user device 102. In various embodiments, the server computer 120 can access the accounts 124 and retrieve an account 124 associated with the user device 102. As noted above, the server computer 120 can execute a query against the accounts 124, search the accounts 124, send a request for a particular account 124 (e.g., associated with a particular identity), and/or otherwise obtain the account 124 associated with the user device 102. As noted above, the accounts 124 can include one or more identifiers. As such, the server computer 120 can search the accounts 124 and/or request a search of the accounts 124 based on the identifying information obtained as part of the activity data 116 in various embodiments. It can be appreciated that operation 304 can also include obtaining the account 124 (or retrieving the account 124 directly). It should be understood that this example embodiment is illustrative, and therefore should not be construed as being limiting in any way.

From operation 304, the method 300 can proceed to operation 306. At operation 306, the server computer 120 can identify, from the account 124 associated with the user device 102, a profile defined for the physical location 110. In operation 306, the server computer 120 can analyze the account 124 obtained in operation 304 and identify one or more profiles (of the account 124). In some embodiments, the server computer 120 can identify profiles that are relevant to and/or that apply at the physical location 110 into which the user device 102 entered as detected in operation 302. In some embodiments, activity data 116 can be obtained as part of operation 302 and the activity data 116 can include information identifying activity that has occurred and/or is occurring at the physical location 110 including one or more identifiers that identify the user device 102, activity information that describes what activity has occurred and/or is occurring associated with the user device 102, location information that identifies the location at which the activity occurred and/or is occurring, time information that identifies a time at which the activity occurred and/or is occurring, and/or other information describing the activity. In operation 306, the server computer 120 can determine one or more profiles of the account 124 that apply to the user device 102. For example, if the physical location 110 corresponds to a home location for the user device 102, the server computer 120 can identify a “home profile” from the account 124. It should be understood that this example embodiment is illustrative, and therefore should not be construed as being limiting in any way.

From operation 306, the method 300 can proceed to operation 308. At operation 308, the server computer 120 can apply the profile identified in operation 306 to the user device 102. In some embodiments, the server computer 120 can perform operation 308 by identifying one or more settings associated with the profile identified in operation 306 and apply those settings to the user device 102. In some embodiments, for example, the settings can include, for example, settings that define what physical resources (e.g., rooms, doors, or the like) can be accessed by the user device 102, what devices identified in the account 124 are allowed or blocked, what activities are allowed or blocked, what networks and/or network connections are allowed or blocked, what times and/or locations of activity will be allowed or blocked, and other aspects of the accounts 124 and/or profiles thereof as illustrated and described herein, and apply the settings to the user device 102 to manage access to physical resources, networks, virtual private networks 112, services 130, and the like by the user device 102.

Although not separately illustrated in FIG. 3, it should be understood that the server computer 120 can be configured to generate one or more commands 126 for applying the settings of the profile to the user device 102. For example, the server computer 120 can generate and send commands 126 to a network controller 128, monitoring hardware 114, and/or other devices to allow or block access to physical resources, network resources, electronic resources, networks, combinations thereof, or the like. It should be understood that this example embodiment is illustrative, and therefore should not be construed as being limiting in any way.

From operation 308, the method 300 can proceed to operation 310. At operation 310, the server computer 120 can monitor the location of the user device 102 and activity of the user device 102. In some embodiments, the server computer 120 can obtain, for example by requesting, receiving, and/or otherwise accessing, instances and/or streams of activity data 116 and determine, based on the activity data 116, activity of the user device 102, locations of the user device 102, and/or other aspects of the activity and/or location as illustrated and described herein. Because the location and/or activity of the user device 102 can be monitored in additional and/or alternative manners, it should be understood that this example embodiment is illustrative, and therefore should not be construed as being limiting in any way.

From operation 310, the method 300 can proceed to operation 312. At operation 312, the server computer 120 can determine, based on activity of the user device 102 at the location at which the activity occurred, if an action should be taken. In various embodiments, the determination as to whether (or not) action should be taken can be based on a determination as to whether the activity and/or location of the user device 102 meets expectations and/or falls within limits associated with the account 124 and/or profiles or settings thereof. Thus, if the server computer 120 determines that the location and/or activity of the user device 102 meets expectations and/or falls within limits associated with the account 124 and/or profiles or settings thereof, the server computer 120 can determine that no action is to be taken. If, however, the server computer 120 determines that the location and/or activity of the user device 102 does not meet expectations and/or does not fall within limits associated with the account 124 and/or profiles or settings thereof, the server computer 120 can determine that action should be taken. It should be understood that this example embodiment is illustrative, and therefore should not be construed as being limiting in any way.

In some example embodiments of operation 312, the server computer 120 may determine that activity of the user device 102 deviates from normal and/or allowed activity of the user device 102 (e.g., in terms of exceeding or otherwise not satisfying profile settings, location limits, time limits, access limits, and/or other aspects of the accounts 124 and/or profiles thereof). In response to such a determination, the server computer 120 can determine that some action should be taken to limit access and/or activity of the user device 102 at the location. It should be understood that this example embodiment is illustrative, and therefore should not be construed as being limiting in any way.

If the server computer 120 determines, in operation 312, that an action is not to be taken, flow of the method 300 can return to operation 310 and the server computer 120 can continue to monitor the location of the user device 102 and activity of the user device 102. As such, it can be appreciated that operations 310-312 can be iterated until performance of the method 300 is ended or until the server computer 120 determines, in any iteration of operation 312, that an action is to be taken.

If the server computer 120 determines, in any iteration of operation 312 that an action is to be taken, the method 300 can proceed to operation 314. At operation 314, the server computer 120 can take an action with respect to the activity of the user device 102. For example, if the server computer 120 determines, in operation 312, that an alert 132 should be generated, the server computer 120 can create and deliver the alert 132 to an alert recipient 134 in operation 314. The alert 132 can inform the alert recipient 134 of the issue, and the alert recipient 134 can take various other actions (e.g., the alert recipient 134 can correspond to a device of a network operator, or the like). It should be understood that this example embodiment is illustrative, and therefore should not be construed as being limiting in any way.

In another contemplated example, the server computer 120 can determine, in operation 312, that some activity monitored in operation 310 should be blocked. In operation 314, the server computer 120 can create and deliver a command 126 to the network controller 128 or the monitoring hardware 114 to block the activity. It should be understood that this example embodiment is illustrative, and therefore should not be construed as being limiting in any way. In some other embodiments, the server computer 120 can determine that additional review of the activity should be performed by some other entity and can take steps in operation 314 to trigger that review and/or take other actions as illustrated and described herein. Because various actions can be taken in accordance with various embodiments of the concepts and technologies disclosed herein, it should be understood that these example actions are illustrative, and therefore should not be construed as being limiting in any way.

From operation 314, the method 300 can proceed to operation 316. The method 300 can end at operation 316. Although FIG. 3 is illustrated with the method 300 ending after operation 316, it should be understood that the method 300 can be repeated and/or portions thereof iterated for any amount of time. Thus, as illustrated in FIG. 3, the method 300 can return to operation 310 from operation 314 in some embodiments, and may not end until the monitoring of the user device 102 is terminated. It should be understood that this example embodiment is illustrative, and therefore should not be construed as being limiting in any way.

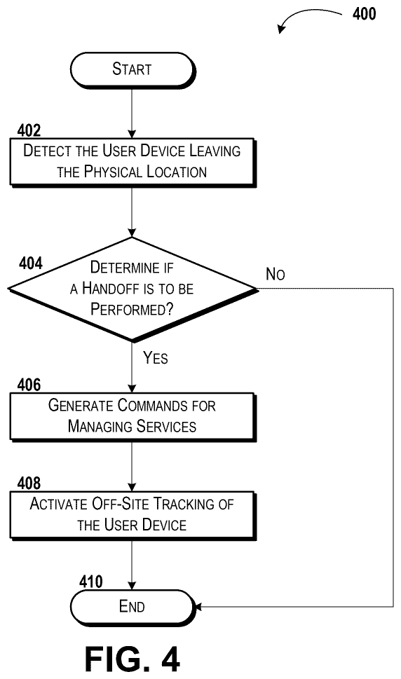

Turning now to FIG. 4, aspects of a method 400 for manage services 130 or other resource usage away from a physical location 110 and/or after a handoff using a network management system will be described in detail, according to an illustrative embodiment. For purposes of illustrating and describing the concepts of the present disclosure, the method 400 is described herein as being performed by the server computer 120 via execution of one or more software modules such as, for example, the network management service 118. It should be understood that additional and/or alternative devices and/or network nodes can provide the functionality described herein via execution of one or more modules, applications, and/or other software including, but not limited to, the network management service 118. Thus, the illustrated embodiments are illustrative, and should not be viewed as being limiting in any way.

The method 400 begins at operation 402. At operation 402, the server computer 120 can detect the user device 102 leaving the physical location 110. In some embodiments of operation 402, the server computer 120 can detect the user device 102 leaving the physical location 110 based on activity data 116 and/or other information. In some embodiments, the server computer 120 can monitor location of the user device 102 and detect the user device 102 leaving the physical location 110. In some other embodiments, the server computer 120 can determine that the user device 102 is not located at the physical location 110 based on activity data 116 and/or other information.

From operation 402, the method 400 can proceed to operation 404. At operation 404, the server computer 120 can determine if a handoff is to be performed. As used herein, a “handoff” can be used to refer to continuing to monitor a user device 102 after it has left a physical location 110 (and thereby left the range and/or control of monitoring hardware 114 at the physical location 110). Thus, a handoff can be performed to provide continuity in terms of monitoring activity and/or location of the user device 102. It should be understood that this example embodiment is illustrative, and therefore should not be construed as being limiting in any way.

In some embodiments, the server computer 120 can determine that a handoff (for continued monitoring) should be performed to continue monitoring the user device 102 off-site from the physical location 110. In some embodiments, for example, the server computer 120 may have detected unexpected and/or unallowed activity at the physical location 110 (as illustrated in operation 312 of the method 300 illustrated in FIG. 3). In response to detecting such activity, the server computer 120 can determine that continued monitoring is desired and therefore can determine that a handoff should be performed to continue monitoring the user device 102 after leaving the physical location 110. In some other embodiments, the server computer 120 can determine that a handoff should be performed for other reasons, for example, based on default rules, based on profile or other settings of an account 124, based on configurations, or the like. As such, it should be understood that handoffs can be performed of any number of reasons and the above example embodiments should not be construed as being limiting in any way.

If the server computer 120 determines, in operation 404, that a handoff is to be performed, the method 400 can proceed to operation 406. At operation 406, the server computer 120 can generate commands 126 for managing services 130 and/or other resource access by the user device 102 such as access to physical resources, electronic resources, networks, virtual private networks 112, or the like. The commands 126 generated by the server computer 120 can include computer-executable instructions that, when executed by a recipient such as the network controller 128, the monitoring hardware 114, or the like, can cause the recipient to take actions to modify an ability of the user device 102 to access a physical or electronic resource.

For example, the commands 126 can cause a recipient to block the user device 102 from creating or using certain connections, accessing physical resources (e.g., using an access control device to access a door, room, or the like), blocking physical access at the physical location 110, blocking network connections of the user device 102, or the like. Because other types of resource access restrictions are illustrated and described herein, it should be understood that these example embodiments are illustrative, and therefore should not be construed as being limiting in any way.

From operation 406, the method 400 can proceed to operation 408. At operation 408, the server computer 120 can activate off-site tracking of the user device 102. It can be appreciated that the commands 126 generated in operation 406 also can be created to cause the monitoring hardware 114 that operates off-site from the physical location 110 to initiate monitoring of the location and/or activity of the user device 102 outside of the physical location 110. Thus, continued monitoring of the user device 102 and/or activity thereof can continue once the user device 102 leaves the physical location 110 when a handoff is requested and/or at other times. Because monitoring of the user device 102 outside of the physical location 110 can be conducted for additional and/or alternative reasons, it should be understood that these example embodiments are illustrative, and therefore should not be construed as being limiting in any way.

From operation 408, the method 400 can proceed to operation 410. The method 400 also can proceed to operation 410 from operation 404 if the server computer 120 determines, in operation 404, that no handoff is to be performed. The method 400 can end at operation 410.

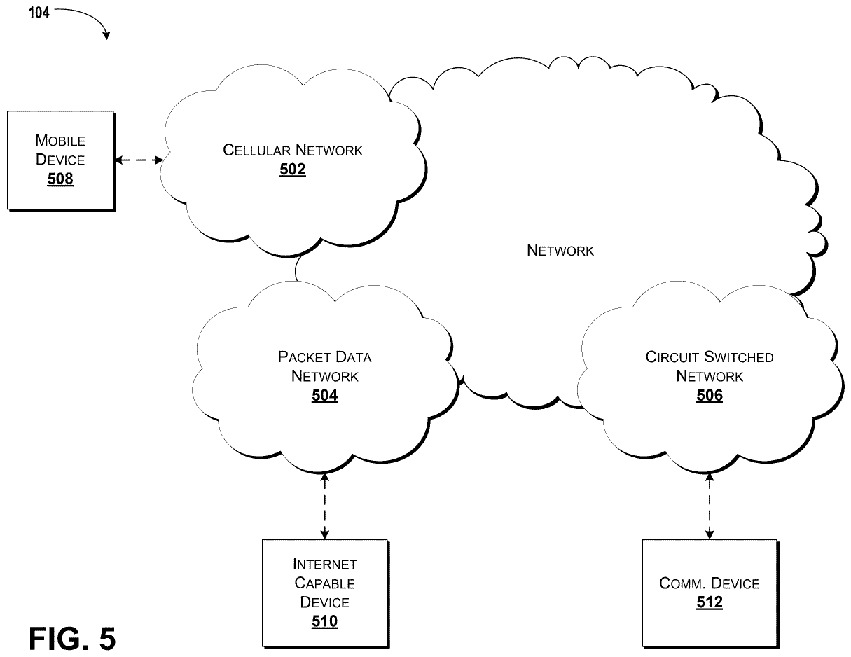

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, 6G mobile communication standards, other mobile communications standards, and evolved and future mobile communications standards. Moreover, the cellular network 502 may facilitate communications over various channel access methods (which may or may not be used by the aforementioned standards) including, but not limited to, TDMA, FDMA, W-CDMA, OFDM, SDMA, and the like. In addition, the cellular network 502 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

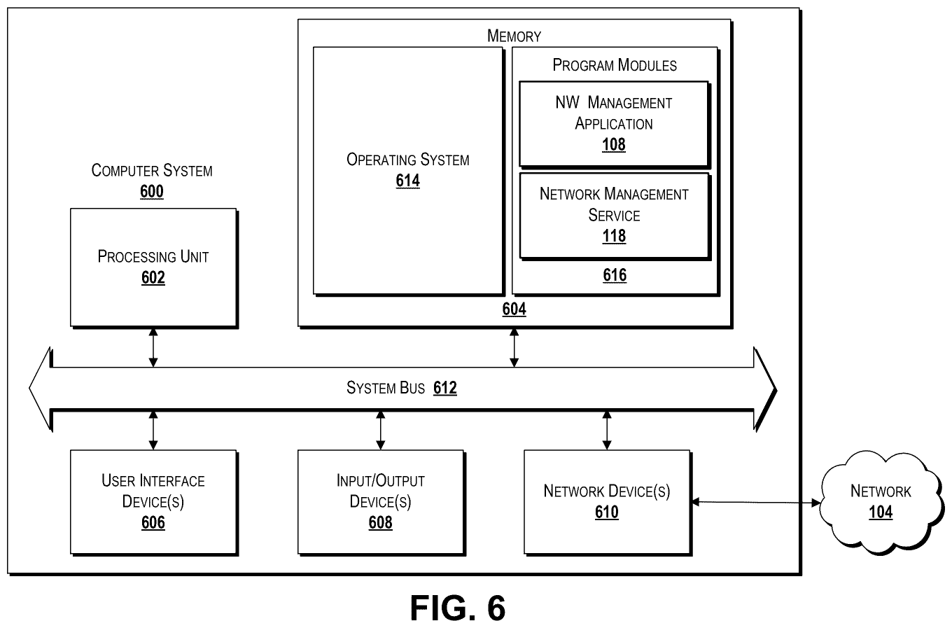

FIG. 6 is a block diagram illustrating a computer system 600 configured to provide the functionality described herein for providing converged network services using a network management system, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the network management application 108 and/or the network management service 118. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, and 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the activity data 116, account data 122, accounts 124, commands 126, alerts 132, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

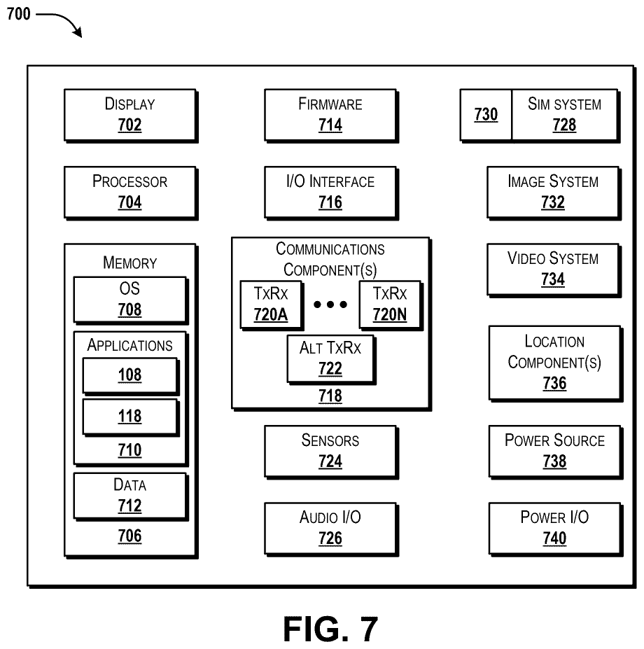

Turning now to FIG. 7, an illustrative mobile device 700 and components thereof will be described. In some embodiments, the user device 102 described above with reference to FIGS. 1-4 can be configured as and/or can have an architecture similar or identical to the mobile device 700 described herein in FIG. 7. It should be understood, however, that the user device 102 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, settings, account information for accounts 124, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the network management application 108, the network management service 118, other computer-executable instructions stored in a memory 706, or the like. In some embodiments, the applications 710 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring accounts 124, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the network management application 108, the network management service 118, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, the activity data 116, account data 122, accounts 124, commands 126, alerts 132, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

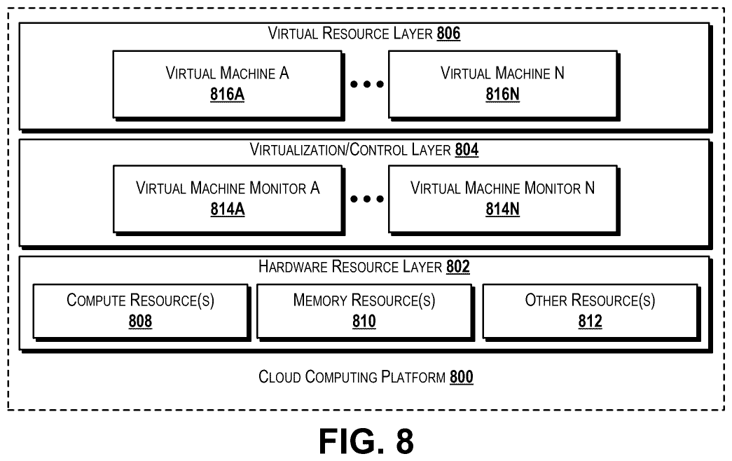

FIG. 8 illustrates an illustrative architecture for a cloud computing platform 800 that can be capable of executing the software components described herein for providing converged network services using a network management system and/or for interacting with the network management application 108 and/or the network management service 118. Thus, it can be appreciated that in some embodiments of the concepts and technologies disclosed herein, the cloud computing platform 800 illustrated in FIG. 8 can be used to provide the functionality described herein with respect to the user device 102, the server computer 120, and/or other devices such as the monitoring hardware 114, the network controller 128, the alert recipient 134, or other devices.

The cloud computing platform 800 thus may be utilized to execute any aspects of the software components presented herein. Thus, according to various embodiments of the concepts and technologies disclosed herein, the network management application 108 and/or the network management service 118 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the network management application 108 and/or the network management service 118 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the network management application 108, the network management service 118, and/or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the activity data 116, account data 122, accounts 124, commands 126, alerts 132, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing converged network services using a network management system have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
detecting, based on activity data generated by monitoring hardware located at a physical location, a user device at the physical location, wherein the activity data comprises an identifier associated with the user device, activity information that identifies an activity occurring at the physical location, and location information that identifies a geographic location of the user device,
identifying, based on the identifier, an account associated with the user device, the account comprising a profile including settings for the user device,
identifying, based on the activity data, the profile from the account,
applying the settings for the user device to the user device,
monitoring, based on additional instances of activity data, location and activity of the user device, and
in response to determining, based on the location and activity of the user device, that an action should be taken, taking the action to manage access of the user device to a physical resource at the physical location and to manage access of the user device to an electronic resource.

2. The system of claim 1, wherein the monitoring hardware comprises an access control device that allows or blocks access to the physical resource, and wherein managing access of the user device to the physical resource comprises blocking the access of the user device to the physical resource.

3. The system of claim 1, wherein the electronic resource comprises a virtual private network associated with the physical location, and wherein managing access of the user device to the virtual private network comprises blocking access of the user device to the virtual private network.

4. The system of claim 1, wherein taking the action comprises generating a command and sending the command to a network controller, wherein the network controller blocks the access of the user device to the electronic resource.

5. The system of claim 1, wherein taking the action comprises generating a command and sending the command to a network controller, wherein the network controller allows the user device to access a virtual private network associated with the physical location.

6. The system of claim 1, wherein the computer-executable instructions, when executed by the processor, cause the processor to perform operations further comprising:
detecting, based on the activity data, the user device leaving the physical location;
determining if a handoff is to be performed to enable off-site monitoring of the user device; and
in response to determining that the handoff is to be performed, activating the off-site monitoring of the user device by a further instance of monitoring hardware.

7. The system of claim 1, wherein the computer-executable instructions, when executed by the processor, cause the processor to perform operations further comprising:
detecting, based on the activity data, the user device leaving the physical location;
determining if a handoff is to be performed to enable off-site monitoring of the user device;
in response to determining that the handoff is to be performed, generating a command to manage services associated with the user device;
sending the command to a network controller to manage the services associated with the user device; and
activating off-site tracking of the user device by a further instance of monitoring hardware.

8. A method comprising:
detecting, at a computer comprising a processor and based on activity data generated by monitoring hardware located at a physical location, a user device at the physical location, wherein the activity data comprises an identifier associated with the user device, activity information that identifies an activity occurring at the physical location, and location information that identifies a geographic location of the user device;
identifying, by the processor and based on the identifier, an account associated with the user device, the account comprising a profile including settings for the user device;
identifying, by the processor and based on the activity data, the profile from the account;
applying, by the processor, the settings for the user device to the user device;
monitoring, by the processor and based on additional instances of activity data, location and activity of the user device; and
in response to determining, based on the location and activity of the user device, that an action should be taken, taking, by the processor, the action to manage access of the user device to a physical resource at the physical location and to manage access of the user device to an electronic resource.

9. The method of claim 8, wherein the monitoring hardware comprises an access control device that allows or blocks access to the physical resource, and wherein managing access of the user device to the physical resource comprises blocking the access of the user device to the physical resource.

10. The method of claim 8, wherein the electronic resource comprises a virtual private network associated with the physical location, and wherein managing access of the user device to the virtual private network comprises blocking access of the user device to the virtual private network.

11. The method of claim 8, wherein taking the action comprises generating a command and sending the command to a network controller, wherein the network controller blocks the access of the user device to the electronic resource.

12. The method of claim 8, further comprising:
detecting, based on the activity data, the user device leaving the physical location;
determining if a handoff is to be performed to enable off-site monitoring of the user device; and
in response to determining that the handoff is to be performed, activating the off-site monitoring of the user device by a further instance of monitoring hardware.

13. The method of claim 8, further comprising:
detecting, based on the activity data, the user device leaving the physical location;
determining if a handoff is to be performed to enable off-site monitoring of the user device;
in response to determining that the handoff is to be performed, generating a command to manage services associated with the user device;
sending the command to a network controller to manage the services associated with the user device; and
activating off-site tracking of the user device by a further instance of monitoring hardware.

14. A computer storage medium having computer-executable instructions stored thereon that, when executed by a processor, cause the processor to perform operations comprising:
detecting, based on activity data generated by monitoring hardware located at a physical location, a user device at the physical location, wherein the activity data comprises an identifier associated with the user device, activity information that identifies an activity occurring at the physical location, and location information that identifies a geographic location of the user device;
identifying, based on the identifier, an account associated with the user device, the account comprising a profile including settings for the user device;
identifying, based on the activity data, the profile from the account;
applying the settings for the user device to the user device;
monitoring, based on additional instances of activity data, location and activity of the user device; and
in response to determining, based on the location and activity of the user device, that an action should be taken, taking the action to manage access of the user device to a physical resource at the physical location and to manage access of the user device to an electronic resource.

15. The computer storage medium of claim 14, wherein the monitoring hardware comprises an access control device that allows or blocks access to the physical resource, and wherein managing access of the user device to the physical resource comprises blocking the access of the user device to the physical resource.

16. The computer storage medium of claim 14, wherein the electronic resource comprises a virtual private network associated with the physical location, and wherein managing access of the user device to the virtual private network comprises blocking access of the user device to the virtual private network.

17. The computer storage medium of claim 14, wherein taking the action comprises generating a command and sending the command to a network controller, wherein the network controller blocks the access of the user device to the electronic resource.

18. The computer storage medium of claim 14, wherein taking the action comprises generating a command and sending the command to a network controller, wherein the network controller allows the user device to access a virtual private network associated with the physical location.

19. The computer storage medium of claim 14, wherein the computer-executable instructions, when executed by the processor, cause the processor to perform operations further comprising:
detecting, based on the activity data, the user device leaving the physical location;
determining if a handoff is to be performed to enable off-site monitoring of the user device; and
in response to determining that the handoff is to be performed, activating the off-site monitoring of the user device by a further instance of monitoring hardware.

20. The computer storage medium of claim 14, wherein the computer-executable instructions, when executed by the processor, cause the processor to perform operations further comprising:
detecting, based on the activity data, the user device leaving the physical location;
determining if a handoff is to be performed to enable off-site monitoring of the user device;
in response to determining that the handoff is to be performed, generating a command to manage services associated with the user device;
sending the command to a network controller to manage the services associated with the user device; and
activating off-site tracking of the user device by a further instance of monitoring hardware.
